(19) United States
(12) Patent Application Publication
(10) Pub. No.: US 2025/0258712 A1
(43) Pub. Date: Aug. 14, 2025

(54) METHOD, DEVICE, AND STORAGE MEDIUM FOR DATA PROCESSING

(71) Applicant: Bytedance Technology Ltd., Grand Cayman (KY)

(72) Inventors: Wei Zhou, Los Angeles, CA (US); Hanzhi Yang, Culver City, CA (US); Sandeep Damacharla, Culver City, CA (US); Aleksei Statkevich, Los Angeles, CA (US); Chuanyun Fang, Culver City, CA (US)

(21) Appl. No.: 19/193,381

(22) Filed: Apr. 29, 2025

(51) Int. Cl. G06F 9/50

(52) U.S. Cl. CPC G06F 9/5027

(57) ABSTRACT

Embodiments of the disclosure provide a solution for data processing. The solution includes: receiving, from a client device, at least one configuration parameter for creating a data processing task; determining, based on the at least one configuration parameter, a task mode for the data processing task, the task mode being selected from a single-node mode and a multi-node mode; and creating, based on the at least one configuration parameter and the task mode, the data processing task with one or more processing nodes in a data processing engine.

### FIELD

The disclosed example embodiments relate generally to the field of computer science, particularly to a method, device, and storage medium for data processing.

### BACKGROUND

The data processing engine is a crucial execution component in data ingestion and integration operations. It links data reading, writing, and processing modules and manages the data flow among them. During the data ingestion, the engine reads data from various sources like databases and files and transfers it to the processing modules. In the processing stage, it coordinates data cleaning, aggregation, and calculations. Finally, in the data writing stage, the engine directs the processed data to storage destinations such as data warehouses or lakes. By efficiently managing the data flow, it ensures the smooth operation of data ingestion and integration tasks.

### SUMMARY

In a first aspect of the present disclosure, there is provided a method of data processing. The method includes: receiving, from a client device, at least one configuration parameter for creating a data processing task; determining, based on the at least one configuration parameter, a task mode for the data processing task, the task mode being selected from a single-node mode and a multi-node mode; and creating, based on the at least one configuration parameter and the task mode, the data processing task with one or more processing nodes in a data processing engine.

In a second aspect of the present disclosure, there is provided an apparatus for data processing. The apparatus includes: a reception module configured to receive, from a client device, at least one configuration parameter for creating a data processing task; a determination module configured to determine, based on the at least one configuration parameter, a task mode for the data processing task, the task mode being selected from a single-node mode and a multi-node mode; and a creation module configured to create, based on the at least one configuration parameter and the task mode, the data processing task with one or more processing nodes in a data processing engine.

In a third aspect of the present disclosure, there is provided an electronic device. The device includes at least one processing unit; and at least one memory coupled to the at least one processing unit and storing instructions executable by the at least one processing unit, the instructions, when executed by the at least one processing unit, causing the device to perform the steps of the method of the first aspect.

In a fourth aspect of the present disclosure, a non-transitory computer-readable storage medium is provided. The non-transitory computer-readable storage medium has a computer program stored thereon which, when executed by an electronic device, causes the electronic device to perform the steps of the method of the first aspect.

It should be understood that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2A illustrates a schematic diagram of an example architecture of data integration;

FIG. 2B illustrates a schematic diagram of an example architecture of data ingestion;

FIG. 3 illustrates a schematic diagram of an example architecture 300 of a multi-node mode in accordance with some embodiments of the present disclosure;

FIG. 4 illustrates a schematic diagram of an example architecture 400 of a single-node mode in accordance with some embodiments of the present disclosure;

FIG. 5 illustrates a schematic diagram of an example architecture for event storage in accordance with some embodiments of the present disclosure;

FIG. 6 illustrates a flow chart of a process for data processing in accordance with some embodiments of the present disclosure;

FIG. 7 illustrates a block diagram of an apparatus for data processing in accordance with some embodiments of the present disclosure; and

FIG. 8 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it should be understood that the present disclosure may be implemented in various forms and should not be interpreted as limited to the embodiments described herein. On the contrary, these embodiments are provided for a more thorough and complete understanding of the present disclosure. It should be understood that the drawings and embodiments of the present disclosure are only for the purpose of illustration and are not intended to limit the scope of protection of the present disclosure.

In the description of the embodiments of the present disclosure, the term “including” and similar terms should be understood as open inclusion, that is, “including but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. As used herein, the term “model” can represent the matching degree between various data. For example, the above matching degree can be obtained based on various technical solutions currently available and/or to be developed in the future.

It should be understood that the data involved in this technical proposal (including but not limited to the data itself, data acquisition or use) shall comply with the requirements of corresponding laws, regulations and relevant provisions.

It should be understood that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It should be understood that the above notification and acquisition of user authorization process are only schematic and do not limit the embodiments of the present disclosure. Other methods that meet relevant laws and regulations may also be applied to the implementation of the present disclosure.

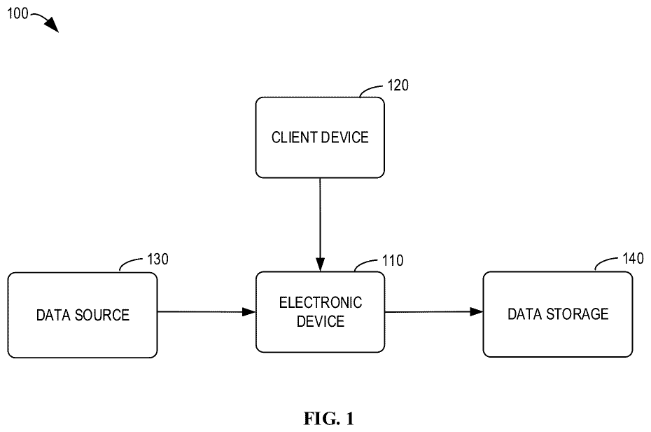

FIG. 1 illustrates a schematic diagram of an example environment 100 in which embodiments of the present disclosure can be implemented. The environment 100 involves one or more data sources 130, one or more data storage 140, an electronic device 110 and a client device 120. The electronic device 110 may be any type of servers capable of providing computing capability, including but not limited to, a mainframe, an edge computing node, an edge device in cloud environment, and the like. The electronic device 110 may receive a configuration from the client device 120. The configuration is used for data processing associated with data from the data source 130.

The data source 130 may be an online or offline data source, and may be or may include relational databases, non-relational databases, file systems (such as CSV, JSON files, etc.), real-time data streams, and various cloud services. The data storage 140 may include data warehouses, data lakes, or other databases, etc., to support various data-driven applications such as data analysis, report generation, data mining, and so on.

It should be understood that the structure and function of each element in the environment 100 is described for illustrative purposes only and does not imply any limitations on the scope of the present disclosure.

As mentioned above, the data processing engine is a crucial execution component in data ingestion and integration operations. It links data reading, writing, and processing modules and manages the data flow among them. In addition to the implementation of read, write and processing modules, the engine includes all runtime parts of a task. The engine has a significant impact on task performance and resource usage. Data processing can include data integration and data ingestion.

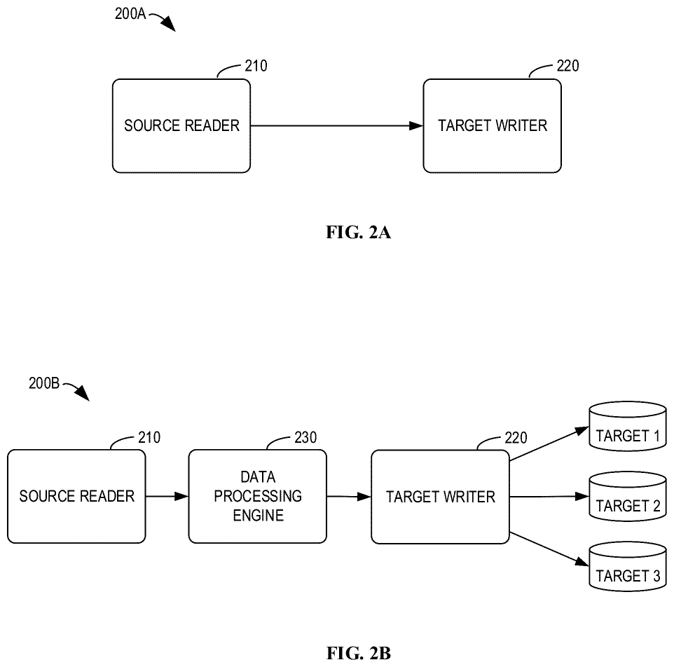

Data integration plays the role of a data mover in the data platform. It has the following technical characteristics: the scale of the processed data varies greatly, and the logic of data processing is relatively simple. FIG. 2A illustrates a schematic diagram of an example architecture 200A of data integration. The architecture 200A involves a source reader 210 and a target writer 220. The source reader 210 reads data from a data source, and the target writer 220 stores the processed data into the specified target data storage.

Data ingestion provides data in the required format for various downstream data consumers. It has the following technical characteristics: the scale of the processed data is large, and the logic of data processing is relatively simple. FIG. 2B illustrates a schematic diagram of an example architecture 200B of data ingestion. The architecture 200B involves the source reader 210, the target writer 220, and a data processing engine 230. The source reader 210 reads data from one or more data sources, the data processing engine 230 performs processing operations on the read data, and the target writer 220 stores the processed data into one or more target data storages, such as target 1, target 2, target 3, and the like.

In some solutions involving data ingestion and data integration, a general-purpose framework is used as the execution engine. The advantage of this approach is the high development efficiency based on the general-purpose framework. For certain scenarios, customized systems, such as a simple microservices system, can be developed for data ingestion and data integration to customize the implementation of relevant core functions. The benefit of this approach is that it can meet the requirements of specific scenarios or improve the performance of the processing system for specific scenarios through customization. However, customization leads to poor generality.

For example, many functions of general-purpose platforms are not relevant to current data ingestion or data integration use cases. As an execution engine for data ingestion and data integration, there is relatively high-performance overhead. In some scenarios, the development and technical iteration progress of data integration is restricted by the collaborative iteration speed of the general-purpose platform.

Therefore, it is expected to construct a new type of lightweight and efficient engine specifically for current data ingestion and data integration needs.

According to embodiments of the present disclosure, an improved solution for data processing is proposed. In the solution, an electronic device receives, from a client device, at least one configuration parameter for creating a data processing task. The electronic device determines, based on the at least one configuration parameter, a task mode for the data processing task. The task mode is selected from a single-node mode and a multi-node mode. The electronic device creates, based on the at least one configuration parameter and the task mode, the data processing task with one or more processing nodes in a data processing engine.

In this way, the data processing engine focuses on relevant functional features, remains lightweight, and is optimized for data ingestion and integration scenarios to improve engine efficiency.

In the following, some example embodiments of the present disclosure will be described in detail with reference to the accompanying drawings.

Referring to FIG. 1, the electronic device 110 receives at least one configuration parameter from the client device 120. In other words, the client device 120 submits a job instructing the creation and execution of a data processing task. The configuration parameter(s) is used for creating the data processing task. For example, the configuration parameters include the number of processing nodes, the number of threads, and the like, which are required for defining how the data processing task is to be executed. There are no limitations on the various suitable configuration parameters that can be received according to the present disclosure.

The electronic device 110 determines a task mode for the data processing task based on the configuration parameter(s). The task mode is selected from a single-node mode and a multi-node mode. For example, a data processing engine provides a running environment for the data processing task. The data processing engine includes a plurality of processing nodes. If a single processing node is utilized to create the data processing task, the data processing task may be referred to as a single-node mode task. If a plurality of processing nodes are utilized to create the data processing task, the data processing task may be referred to as a multi-node mode task. The single-node mode or the multi-node mode may be determined based on the number of processing nodes and/or the number of threads configured. In this way, the electronic device 110 can determine the task mode based on the scale of the computation resource required.

The electronic device 110 creates, based on the configuration parameter(s) and the selected task mode, the data processing task with one or more processing nodes in a data processing engine. In other words, the electronic device creates multi-node or single-node mode tasks based on the configuration parameters submitted by the client device 120. Upon creating the data processing task, the electronic device 110 may receive data to be processed from the data source 130. After the execution of the data processing task, the electronic device 110 may output the data processed to the data storage 140. In some examples, in response to completion of the data processing task, the electronic device 110 may release the one or more processing nodes in the data processing engine. In this way, the present disclosure can dynamically utilize the processing nodes in the data processing engine to complete the corresponding data processing task and release the processing nodes after the completion of the data processing task.

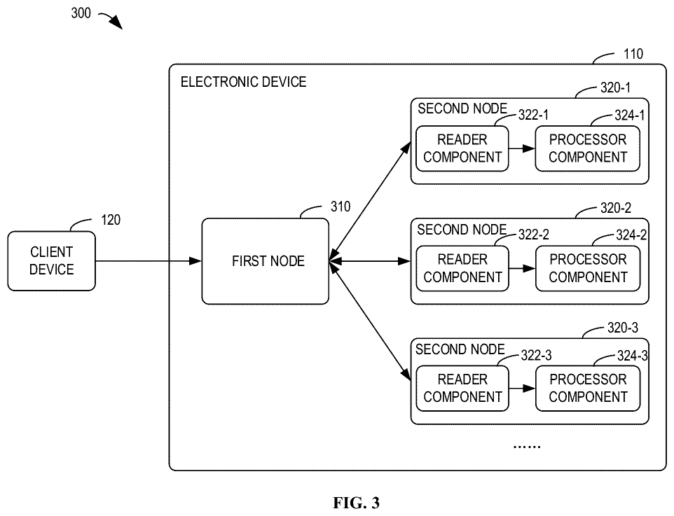

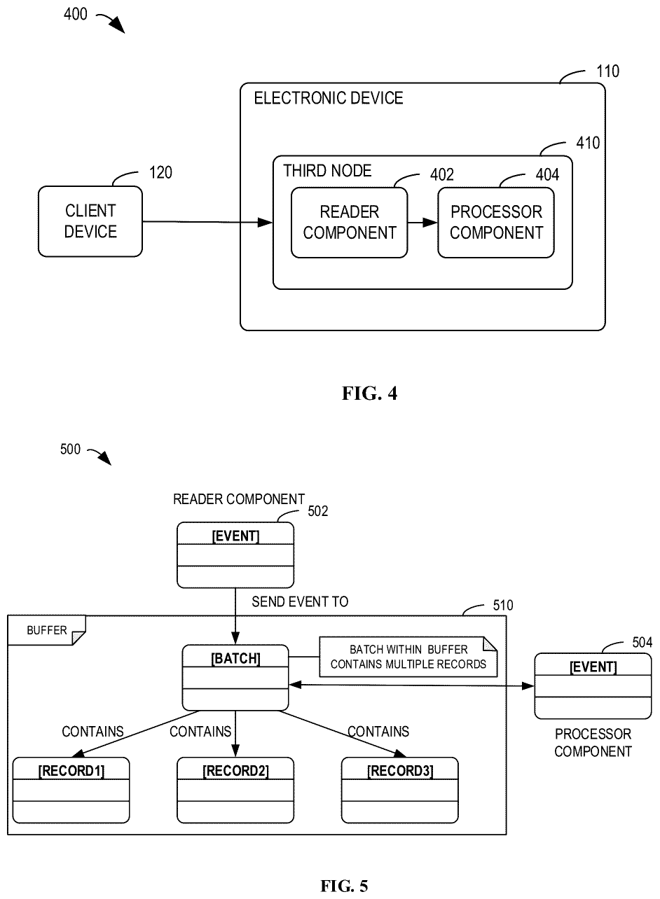

During the execution of the data processing task, the multi-node task or single-node mode task is created. The following will describe the details with reference to FIGS. 3 and 4.

Reference is now made to FIG. 3, which illustrates a schematic diagram of an example architecture 300 of a multi-node mode in accordance with some embodiments of the present disclosure. The architecture 300 involves the electronic device 110 and the client device 120. The electronic device 110 includes a data processing engine (not shown) which includes a plurality of processing nodes. The architecture 300 will be described with reference to FIG. 1.

The electronic device 110 receives the configuration parameter(s) from the client device 120. In some examples, the electronic device 110 may determine that the task mode for the data processing task is the multi-node mode and create a first node (also referred to as job manager node) 310 and a plurality of second nodes (also referred to as task manager nodes) 320 with the one or more processing nodes in the data processing engine. The plurality of second nodes may include nodes, such as second node 320-1, second node 320-2, second node 320-3 and the like, which may be referred to as second node 320, collectively or individually.

The first node 310 may be configured to coordinate among the plurality of second nodes 320, and the second nodes 320 may be configured to perform data processing. Each second node 320 communicates with the first node 310. For example, the first node 310 may establish a remote procedure call (e.g., gRPC) communication with each second node 320 to synchronize status information and heartbeats.

The electronic device 110 may create the data processing task based on the first node 310 and the plurality of second nodes 320. For example, the configuration parameter indicates 500 processing nodes. The electronic device 110 may create the data processing task by allocating one processing node as first node 310 and the remaining 499 processing nodes as second nodes 320.

In some examples, the data processing task may include a plurality of processing operations (also referred to as subtasks). Each subtask may be performed by a single second node 320. There is no need for data transmission between second nodes 320, which ensures the isolation between subtasks and avoids the potential overhead of network data transmission between second nodes 320.

In some examples, each second node 320 may include a reader component (also referred to as source reader) 322 and a processor component (also referred to as sink writer) 324. The reader component 322 (such as reader component 322-1, reader component 322-2, reader component 322-3 and the like, which may be referred to as reader component 322, collectively or individually) may be configured to read data to be processed from the data source 130. The processor component 324 (such as processor component 324-1, processor component 324-2, processor component 324-3 and the like, which may be referred to as processor component 324, collectively or individually) may be configured to perform at least one processing operation of the data processing task and output processed data to a further second node.

For instance, the data processing task may include a plurality of subtasks. One subtask (e.g., for extraction) of the plurality of subtasks is performed by the second node 320-1. The data extracted by the processor component 324-1 then requires additional processing (e.g., transformation), which is performed as another subtask by the processor component 324-2.

Alternatively, the processor component 324 may be configured to perform at least one processing operation of the data processing task and output processed data as a part of a result of the data processing task. For example, the data processing task may include a plurality of subtasks. The processor component 324 in each second node 320 performs one of the plurality of subtasks and outputs the corresponding processed data. The processed data output by all the second nodes 320 consists of the result of the data processing task. In this way, the reader component 322 and the processor component 324 that perform the same task (or subtask) are all created within the same second node 320, thereby avoiding the potential overhead of data transmission between second nodes 320 and simplifying the complexity of the engine architecture.

In some examples, the processor component 324 may include an engine for extracting, transforming and loading data. Such engine is also referred to as ETL engine. For example, the processor component 324 may extract data from the data source 130, clean and transform the extracted data, and then load the processed data into the data storage 140.

In view of the above, each second node 320 only needs to include two logical components to meet the data ingestion and data integration operations. That is, the reader component 322 is used for data reading, and the processor component 324 is used for processing user data and sending the processed data to the downstream data storage 140. Such data processing architecture has many advantages compared with the frameworks of existing technologies. For example, it simplifies the complexity of the client configuration tasks and the number of configuration parameters and improves the execution efficiency of the data processing tasks.

In some examples, the configuration parameters may include the number of working threads of the reader component 322 and/or the processor component 324. Since the processor component 324 requires more computing resources, the client device 120 may balance and efficiently utilize the resources by configuring the ratio of working threads of the reader component 322 and the processor component 324 when submitting the specific job.

The above has introduced that if the scale of the data processing task is large, a multi-node mode task can be created to perform the data processing, and such a processing method can also be called the per-job method. However, in some data integration scenarios, there are usually many small tasks. In the per-job mode, each small task is allocated a job manager node and a task manager node. With such a configuration, the utilization rate of computing resources may be lower than 50% during the peak of data traffic. Even if a single job manager node is used to manage the task manager nodes from different tasks, it is difficult to ensure the isolation between tasks. In such a scenario, the electronic device 110 may create a single-node mode task, which will be described below with reference to FIG. 4.

FIG. 4 illustrates a schematic diagram of an example architecture 400 of a single-node mode in accordance with some embodiments of the present disclosure. The architecture 400 involves the electronic device 110 and the client device 120. The electronic device 110 includes a data processing engine (not shown) which includes a plurality of processing nodes. The architecture 400 will be described with reference to FIG. 1.

The electronic device 110 receives the configuration parameter(s) from the client device 120. In some examples, the electronic device 110 may determine that the task mode for the data processing task is the single-node mode and create a third node (also referred to as unity manager node) 410 with the one or more processing nodes in the data processing engine. The third node 410 may be configured to perform at least one processing operation of the data processing task. The electronic device 110 may create the data processing task, based on the third node 410.

In some examples, the third node 410 may include a reader component 402 and a processor component 404. The reader component 402 may be configured to read data to be processed, and the processor component 404 may be configured to perform at least one processing operation of the data processing task and output processed data as a result of the data processing task. In some examples, the reader component 402 may have the same functionality as the reader component 322, and the processor component 404 may have the same functionality as the processor component 324.

In the single-node mode, the functions of the job manager node and the task manager node are integrated into the unity manager node. In this way, small tasks are completely isolated from each other during task runtime. At the same time, compared with the multi-node mode, since the job manager node is removed, the resource utilization rate is increased (e.g., by nearly twice).

As described above, the data processing task is created, based on the received configuration parameter(s) and the determined task modes, for data ingestion and integration dynamically utilizing one or more processing nodes in the data processing engine. Data ingestion and data integration tasks involve intensive data reading and writing operations. For example, inside the general-purpose engine architecture shown in FIG. 2A, an internal object is created for each read message between the source reader 210 and the target writer 220. In the Java programming and virtual machine operating environment, every time the life cycle of an object is created and maintained, the virtual machine environment incurs additional system overhead. Given that, the embodiments of the present disclosure introduce an object reuse pattern, which will be described below with reference to FIG. 5.

FIG. 5 illustrates a schematic diagram of an example architecture 500 for event storage in accordance with some embodiments of the present disclosure. The architecture 500 involves the reader component 502, the processor component 504 and a buffer 510. The reader component 502 may have the same functionality as the reader component 322 or the reader component 402, and the processor component 504 may have the same functionality as the processor component 324 or the processor component 404. The architecture 500 will be described with reference to FIGS. 3 and 4.

The buffer 510 is configured to receive events (also referred to as messages) from the reader component 502 and store the received events in the form of records. An event is a specific representation of data in the data source 130, and it carries specific information. When the reader component 502 connects to the data source 130 according to predetermined rules and reads the data, every time a piece of data that meets the criteria is read, it will be encapsulated as an event. The buffer 510 is further configured to output the stored events to the processor component 504. In some examples, the processor component 504 may include an ETL engine and a writer component. The buffer 510 may send the stored events to the writer component.

In some examples, the electronic device 110 may receive an event from the reader component. The event may be determined based on the data to be processed from the reader component 502. For example, an event is a fundamental element of data flow in the data processing engine, and it is extracted from the data source 130 by the reader component 502. After the extraction, it may be stored in the buffer 510. If a number of events stored in the buffer 510 is less than a predetermined threshold, the electronic device 110 may store the received event in the buffer 510. For example, the buffer 510 may receive three events from the reader component 502. These events may then be stored as a record 1, record 2 and record 3, respectively. The processor component 504 may access these records multiple times. In this way, these records inside the buffer 510 can be used repeatedly after being created once, and they are exempt from garbage collection during the execution of the data processing task.

In some examples, if the number of events stored in the buffer is greater than the predetermined threshold, the electronic device 110 may flush the buffer 510 by outputting the stored events to the processor component 504 for processing and then store the received event in the buffer 510. For example, the buffer 510 stores multiple events as multiple records. If the buffer 510 is full and receives a new event, the electronic device 110 may output a batch of records to the writer component. Since the writer component writes records in batch mode, this way can improve data throughput while ensuring low latency.

In summary, the embodiments of the present disclosure propose an improved data processing engine architecture. Specifically, according to configuration parameters from the client device 120, the electronic device 110 determines the task mode, such as single-node mode or multiple-node mode, and creates the data processing task using one or more processing nodes in the data processing engine. Upon completing the data processing task, the electronic device 110 may release the processing nodes. In this way, the data processing engine can dynamically allocate processing nodes, maintaining a lightweight architecture and optimizing performance for data ingestion and integration scenarios, thereby enhancing overall engine efficiency.

Additionally, the embodiments of the present disclosure further propose a reuse architecture for event storage. Specifically, after receiving an event, if the number of events in the buffer has not exceeded a predetermined threshold, the event is stored in the buffer. If the number of events in the buffer exceeds the predetermined threshold, the electronic device 110 first writes all the stored events to the writer component, clears the buffer, and then stores the new event. In this way, system overhead can be reduced, latency can be lowered, and data throughput can be improved.

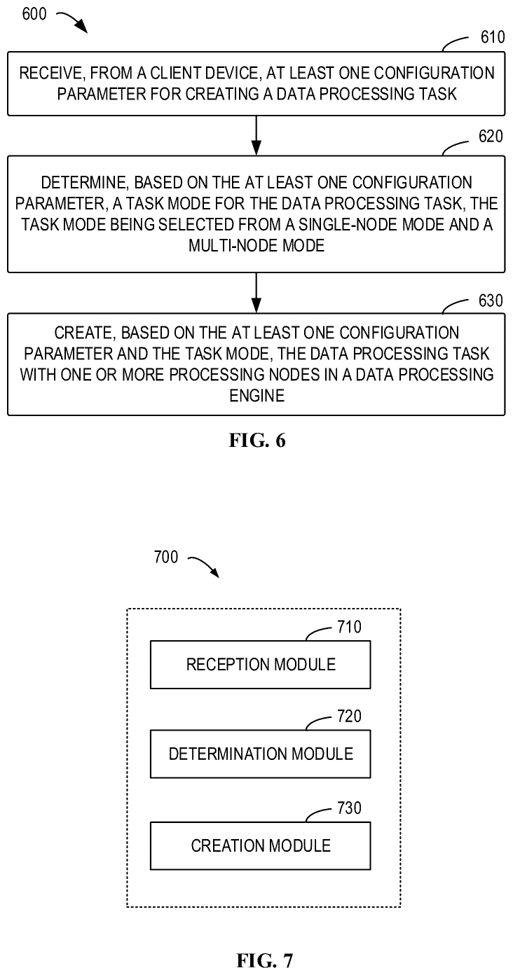

FIG. 6 illustrates a flow chart of a process 600 for data processing in accordance with some embodiments of the present disclosure. The process 600 can be implemented at an electronic device which operates for data processing. For the purpose of discussion, the process 600 will be described with reference to FIG. 1. Thus, the process 600 is implemented at the electronic device 110 of FIG. 1.

At block 610, the electronic device 110 receives, from a client device, at least one configuration parameter for creating a data processing task.

At block 620, the electronic device 110 determines, based on the at least one configuration parameter, a task mode for the data processing task, the task mode being selected from a single-node mode and a multi-node mode.

At block 630, the electronic device 110 creates, based on the at least one configuration parameter and the task mode, the data processing task with one or more processing nodes in a data processing engine.

In some embodiments of the present disclosure, the electronic device 110 in accordance with a determination that the task mode for the data processing task is the multi-node mode, creates a first node and a plurality of second nodes with the one or more processing nodes in the data processing engine, wherein the first node is configured to coordinate among the plurality of second nodes, and the plurality of second nodes is configured to perform data processing; and creates the data processing task based on the first node and the plurality of second nodes.

In some embodiments of the present disclosure, a second node of the plurality of second nodes includes a reader component and a processor component, the reader component is configured to read data to be processed, and the processor component is configured to perform at least one processing operation of the data processing task and output processed data to a further second node or as a part of a result of the data processing task.

In some embodiments of the present disclosure, the electronic device 110 in accordance with a determination that the task mode for the data processing task is the single-node mode, creates a third node with the one or more processing nodes in the data processing engine, wherein the third node is configured to perform at least one processing operation of the data processing task; and creates, based on the third node, the data processing task.

In some embodiments of the present disclosure, the third node includes a reader component and a processor component, the reader component is configured to read data to be processed, and the processor component is configured to perform at least one processing operation of the data processing task and output processed data as a result of the data processing task.

In some embodiments of the present disclosure, the electronic device 110 receives, from the reader component, an event determined based on the data to be processed; and in accordance with a determination that a number of events stored in a buffer is less than a predetermined threshold, stores the received event in the buffer.

In some embodiments of the present disclosure, the electronic device 110 in accordance with a determination that the number of events stored in the buffer is greater than the predetermined threshold, flushes the buffer by outputting the stored events to the processor component for processing; and stores the received event in the buffer.

In some embodiments of the present disclosure, the processor component includes an engine for extracting, transforming and loading data.

In some embodiments of the present disclosure, the electronic device 110 in response to completion of the data processing task, releases the one or more processing nodes in the data processing engine.

FIG. 7 illustrates a block diagram of an apparatus 700 for data processing in accordance with some embodiments of the present disclosure. The apparatus 700 may be implemented, for example, or included at the electronic device 110 of FIG. 1. Various modules/components in the apparatus 700 may be implemented by hardware, software, firmware, or any combination thereof.

As shown, the apparatus 700 includes a reception module 710 configured to receive, from a client device, at least one configuration parameter for creating a data processing task. The apparatus 700 further includes a determination module 720 configured to determine, based on the at least one configuration parameter, a task mode for the data processing task, the task mode being selected from a single-node mode and a multi-node mode. The apparatus 700 further includes a creation module 730 configured to create, based on the at least one configuration parameter and the task mode, the data processing task with one or more processing nodes in a data processing engine.

In some embodiments, the creation module 730 is configured to in accordance with a determination that the task mode for the data processing task is the multi-node mode, create a first node and a plurality of second nodes with the one or more processing nodes in the data processing engine, wherein the first node is configured to coordinate among the plurality of second nodes, and the plurality of second nodes is configured to perform data processing; and create the data processing task based on the first node and the plurality of second nodes.

In some embodiments, a second node of the plurality of second nodes includes a reader component and a processor component, the reader component is configured to read data to be processed, and the processor component is configured to perform at least one processing operation of the data processing task and output processed data to a further second node or as a part of a result of the data processing task.

In some embodiments, the creation module 730 is configured to in accordance with a determination that the task mode for the data processing task is the single-node mode, create a third node with the one or more processing nodes in the data processing engine, wherein the third node is configured to perform at least one processing operation of the data processing task; and create, based on the third node, the data processing task.

In some embodiments, the third node includes a reader component and a processor component, the reader component is configured to read data to be processed, and the processor component is configured to perform at least one processing operation of the data processing task and output processed data as a result of the data processing task.

In some embodiments, the apparatus 700 further includes an event reception module configured to receive, from the reader component, an event determined based on the data to be processed; and in accordance with a determination that a number of events stored in a buffer is less than a predetermined threshold, store the received event in the buffer.

In some embodiments, the event reception module configured to in accordance with a determination that the number of events stored in the buffer is greater than the predetermined threshold, flush the buffer by outputting the stored events to the processor component for processing; and store the received event in the buffer.

In some embodiments, the processor component includes an engine for extracting, transforming and loading data.

In some embodiments, the apparatus 700 further includes a releasing module configured to in response to completion of the data processing task, release the one or more processing nodes in the data processing engine.

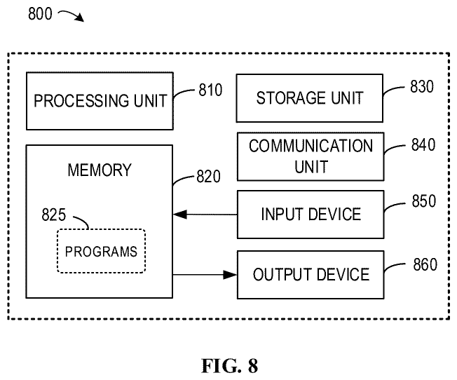

FIG. 8 illustrates a block diagram of an electronic device 800 in which one or more embodiments of the present disclosure can be implemented. It should be understood that the electronic device 800 shown in FIG. 8 is only an example and should not constitute any restriction on the function and scope of the embodiments described herein. The electronic device 800 may be used, for example, to implement the electronic device 110 of FIG. 1. The electronic device 800 may also be configured to implement the apparatus 700 of FIG. 7.

As shown in FIG. 8, the electronic device 800 is in the form of a general computing device. The components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and can execute various processes according to the programs stored in the memory 820. In a multiprocessor system, multiple processing units execute computer executable instructions in parallel to improve the parallel processing capability of the electronic device 800.

The electronic device 800 typically includes a variety of computer storage medium. Such medium may be any available medium that is accessible to the electronic device 800, including but not limited to volatile and non-volatile medium, removable and non-removable medium. The memory 820 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 830 may be any removable or non-removable medium, and may include a machine-readable medium, such as a flash drive, a disk, or any other medium, which can be used to store information and/or data (such as training data for training) and can be accessed within the electronic device 800.

The electronic device 800 may further include additional removable/non-removable, volatile/non-volatile storage medium. Although not shown in FIG. 8, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 820 may include a computer program product 825, which has one or more program modules configured to perform various methods or acts of various embodiments of the present disclosure.

The communication unit 840 communicates with a further computing device through the communication medium. In addition, the functions of components in the electronic device 800 may be implemented by a single computing cluster or multiple computing machines, which can communicate through a communication connection. Therefore, the electronic device 800 may be operated in a networking environment using a logical connection with one or more other servers, a network personal computer (PC), or another network node.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown) through the communication unit 840 as required. The external device, such as a storage device, a display device, etc., communicate with one or more devices that enable users to interact with the electronic device 800, or communicate with any device (for example, a network card, a modem, etc.) that makes the electronic device 800 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It should be understood that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. A method of data processing, comprising:
receiving, from a client device, at least one configuration parameter for creating a data processing task;
determining, based on the at least one configuration parameter, a task mode for the data processing task, the task mode being selected from a single-node mode and a multi-node mode; and
creating, based on the at least one configuration parameter and the task mode, the data processing task with one or more processing nodes in a data processing engine.

2. The method of claim 1, wherein creating the data processing task comprises:
in accordance with a determination that the task mode for the data processing task is the multi-node mode, creating a first node and a plurality of second nodes with the one or more processing nodes in the data processing engine, wherein the first node is configured to coordinate among the plurality of second nodes, and the plurality of second nodes is configured to perform data processing; and
creating the data processing task based on the first node and the plurality of second nodes.

3. The method of claim 2, wherein a second node of the plurality of second nodes comprises a reader component and a processor component, the reader component is configured to read data to be processed, and the processor component is configured to perform at least one processing operation of the data processing task and output processed data to a further second node or as a part of a result of the data processing task.

4. The method of claim 1, wherein creating the data processing task comprises:
in accordance with a determination that the task mode for the data processing task is the single-node mode, creating a third node with the one or more processing nodes in the data processing engine, wherein the third node is configured to perform at least one processing operation of the data processing task; and
creating, based on the third node, the data processing task.

5. The method of claim 4, wherein the third node comprises a reader component and a processor component, the reader component is configured to read data to be processed, and the processor component is configured to perform at least one processing operation of the data processing task and output processed data as a result of the data processing task.

6. The method of claim 3, further comprising:
receiving, from the reader component, an event determined based on the data to be processed; and
in accordance with a determination that a number of events stored in a buffer is less than a predetermined threshold, storing the received event in the buffer.

7. The method of claim 6, further comprising:
in accordance with a determination that the number of events stored in the buffer is greater than the predetermined threshold,
flushing the buffer by outputting the stored events to the processor component for processing; and
storing the received event in the buffer.

8. The method of claim 2, wherein the processor component comprises an engine for extracting, transforming and loading data.

9. The method of claim 1, further comprising:
in response to completion of the data processing task, releasing the one or more processing nodes in the data processing engine.

10. An electronic device, comprising a computer processor coupled to a computer-readable memory unit, the memory unit comprising instructions that when executed by the computer processor implements operations comprising:
receiving, from a client device, at least one configuration parameter for creating a data processing task;
determining, based on the at least one configuration parameter, a task mode for the data processing task, the task mode being selected from a single-node mode and a multi-node mode; and
creating, based on the at least one configuration parameter and the task mode, the data processing task with one or more processing nodes in a data processing engine.

11. The device of claim 10, wherein creating the data processing task comprises:
in accordance with a determination that the task mode for the data processing task is the multi-node mode, creating a first node and a plurality of second nodes with the one or more processing nodes in the data processing engine, wherein the first node is configured to coordinate among the plurality of second nodes, and the plurality of second nodes is configured to perform data processing; and
creating the data processing task based on the first node and the plurality of second nodes.

12. The device of claim 11, wherein a second node of the plurality of second nodes comprises a reader component and a processor component, the reader component is configured to read data to be processed, and the processor component is configured to perform at least one processing operation of the data processing task and output processed data to a further second node or as a part of a result of the data processing task.

13. The device of claim 10, wherein creating the data processing task comprises:
in accordance with a determination that the task mode for the data processing task is the single-node mode, creating a third node with the one or more processing nodes in the data processing engine, wherein the third node is configured to perform at least one processing operation of the data processing task; and
creating, based on the third node, the data processing task.

14. The device of claim 13, wherein the third node comprises a reader component and a processor component, the reader component is configured to read data to be processed, and the processor component is configured to perform at least one processing operation of the data processing task and output processed data as a result of the data processing task.

15. The device of claim 12, wherein the operations further comprise:
receiving, from the reader component, an event determined based on the data to be processed; and
in accordance with a determination that a number of events stored in a buffer is less than a predetermined threshold, storing the received event in the buffer.

16. The device of claim 15, wherein the operations further comprise:
in accordance with a determination that the number of events stored in the buffer is greater than the predetermined threshold,
flushing the buffer by outputting the stored events to the processor component for processing; and
storing the received event in the buffer.

17. The method of claim 11, wherein the processor component comprises an engine for extracting, transforming and loading data.

18. The device of claim 10, wherein the operations further comprise:
in response to completion of the data processing task, releasing the one or more processing nodes in the data processing engine.

19. A non-transitory computer readable storage medium, having a computer program stored thereon which, upon execution by an electronic device, causes the device to perform operations comprising:
receiving, from a client device, at least one configuration parameter for creating a data processing task;
determining, based on the at least one configuration parameter, a task mode for the data processing task, the task mode being selected from a single-node mode and a multi-node mode; and
creating, based on the at least one configuration parameter and the task mode, the data processing task with one or more processing nodes in a data processing engine.

20. The non-transitory computer readable storage medium of claim 19, wherein creating the data processing task comprises:
in accordance with a determination that the task mode for the data processing task is the multi-node mode, creating a first node and a plurality of second nodes with the one or more processing nodes in the data processing engine, wherein the first node is configured to coordinate among the plurality of second nodes, and the plurality of second nodes is configured to perform data processing; and
creating the data processing task based on the first node and the plurality of second nodes.
